(19) United States
(12) Patent Application Publication
(10) Pub. No.: US 2022/0354113 A1
(43) Pub. Date: Nov. 10, 2022

(54) FUMIGANT FORMULATION FOR DRIP APPLICATION

(71) Applicant: Arkema France, Colombes (FR)

(72) Inventors: Patrick Charles, Lacq (FR); Thierry Fouillet, Lacq (FR)

(73) Assignee: Arkema France, Colombes (FR)

(21) Appl. No.: 17/638,495

(22) PCT Filed: Aug. 24, 2020
(86) PCT No.: PCT/FR2020/051494

§ 371 Date: Feb. 25, 2022

(30) Foreign Application Priority Data
Aug. 30, 2019 (FR) FR1909556

(51) Int. Cl. A01N 25/18; A01N 25/04; A01N 41/12

(52) U.S. Cl. CPC A01N 25/18; A01N 25/04; A01N 41/12

(57) ABSTRACT

The present invention relates to the field of soil fumigation, and more particularly to a fumigant formulation comprising from 0.10% to 0.4% by weight of fumigant, said formulation being particularly suitable for dropwise administration, and also to the use thereof. The present invention also relates to a method of pesticide treatment by fumigation of soils and/or substrates that employs such a formulation, administered dropwise.

### CROSS-REFERENCE TO RELATED APPLICATIONS

This application is the U.S. national phase of International Application No. PCT/FR2020/051494, filed 24 Aug. 2020, which claims priority to French Application No. FR 1909556, filed 30 Aug. 2019, the disclosure of each of these applications being incorporated herein by reference in its entirety for all purposes.

### FIELD OF THE INVENTION

The present invention relates to the field of soil and/or substrate fumigation, and more particularly to a fumigant formulation which is suitable for dropwise administration, and also to the use thereof. The present invention also relates to a method of pesticide treatment by fumigation of soils and/or substrates that employs such a formulation, administered dropwise.

### BACKGROUND OF THE INVENTION

Fumigants are well-known chemicals which inhibit or kill the organisms which cause destruction and/or harm to plants, such as nematodes, fungi, insects, weeds, and others. Fumigants most often take the form of volatile liquids, solids, or gases. Fumigants possess the property of diffusing within the soil and/or substrate to be treated, in gaseous form, after they have been administered.

The technique of soil fumigation is currently used in numerous situations (agriculture, arboriculture, horticulture, market garden) and for a wide range of crops. More particularly, fumigation is used for high-added-value plant crops such as, for example, tomato, strawberry, melon, cucumber and bell pepper crops, but also for potato, carrot, vine, fruit tree and cut flower crops, to mention only the main crops in question.

In order to guarantee maximum efficacy, the fumigants are usually deposited on the soil or else introduced into the soil by injection. There are presently two techniques commonly used for administering fumigants, namely:
using shanks, allowing injection into soils to depths of from several centimetres to several tens of centimetres; and
dropwise, with a system placed on the soil or buried.

The main advantages of drip fumigation are the ease of implementation, the flexibility of use, and the reduced toxicity, given that the vector of administration (the solvent) of the fumigant is water.

Among known fumigants, dimethyl disulfide (also called DMDS) is described in the application WO 02/074083 as a broad-spectrum fumigant having nematicidal, fungicidal, insecticidal and bactericidal properties. It may be used alone or in joint application with other fumigants.

However, the fumigants used, and particularly DMDS, are sometimes not very soluble in water. Drip administration may therefore cause problems with dosing of the fumigant on the plot to be treated. Because of its low solubility, the fumigant is not evenly distributed and may accumulate in some areas, while other areas will not be treated sufficiently. Accordingly, depending on the humidity of the ground, atmospheric conditions and conditions of complementary sprinkling which may be carried out, fumigants, including DMDS, may be subject to greater or lesser accumulation in certain regions of the soil or the substrate, so giving rise to a risk, for the crops, of local overdosing or else underdosing.

Moreover, the fumigant may block the drippers and adversely affect the dripper lines if it is used alone, so giving rise to problems with regard as much to the level of efficacy of the fumigation as to the equipment used. Certain fumigants, indeed, especially DMDS, are not compatible with the majority of plastics.

There is therefore a need for a fumigant formulation that allows effective pesticide treatment while ensuring even diffusion of the fumigant used over the soil and/or substrate to be treated.

There is likewise a need for a stable fumigant formulation which allows sufficient solubilization and which is suitable for drip administration.

### SUMMARY OF THE INVENTION

One of the objects of the present invention is therefore to provide a fumigant formulation which is suitable for drip administration.

Another object of the present invention is to provide a stable fumigant formulation, particularly in the form of an emulsion.

Another object of the present invention is to provide a method for pesticide treatment by drip fumigation that is effective and allows even distribution of the fumigant over the soil and/or substrate to be treated, with enhanced ease of use.

Accordingly, the present invention relates to a formulation F comprising water and between 0.10% and 0.40% by volume of a composition C, relative to the total volume of water in the formulation F, said composition C comprising:
at least 80% by weight, preferably at least 90% by weight, of at least one fumigant compound, relative to the total weight of the composition C;
between 0.1% and 20%, preferably between 1% and 10%, by weight of at least one surfactant, relative to the total weight of the composition C; and
optionally an odour-masking agent, for example between 0.1% and 0.5% by weight of an odour-masking agent, relative to the total weight of the composition C.

### DETAILED DESCRIPTION OF THE INVENTION

The formulation F according to the invention is preferably an emulsion, more preferably a microemulsion. For example, the particles of the emulsion have a size of less than or equal to 0.1 μm.

Said formulation F may comprise in particular between 0.10% and 0.30%, preferably between 0.15% and 0.25%, by volume of said composition C, relative to the total volume of water in the formulation F. Said formulation F may comprise between 0.15% and 0.40% by volume of said composition C, relative to the total volume of water in the formulation F.

The present invention therefore relates to a formulation F comprising water and a composition C, said composition C comprising:
at least 80% by weight, preferably at least 90% by weight, of at least one fumigant compound, relative to the total weight of the composition C;
between 0.1% and 20% by weight, preferably between 1% and 10% by weight, of at least one surfactant, relative to the total weight of the composition C; and
optionally an odour-masking agent;
   where the formulation F is characterized in that the [composition C]/[water] volume ratio is between 0.10/100 and 0.40/100 (i.e. between 0.0010 and 0.004), preferably between 0.10/100 and 0.30/100 (i.e. between 0.0010 and 0.003), and more preferably between 0.15/100 and 0.25/100 (i.e. between 0.0015 and 0.0025).

To prepare a formulation of this kind, it is possible in particular to use an emulsifiable fumigant concentrate. According to one particularly preferred embodiment, the emulsifiable concentrate corresponds to the composition C as defined above. It may correspond very preferably to the dimethyl disulfide compositions sold by Arkema under the names Paladin® EC, Accolade® EC and Atomal® 13. According to one embodiment, said composition C does not comprise water. Said composition C may comprise at least one fumigant, preferably DMDS, in an amount of at least strictly superior to 90% by weight, preferably comprised between strictly superior to 90% and 95% by weight, relative to the total weight of the composition C.

The composition C preferably comprises:
at least 90% by weight, for example between 90% and 95% by weight, of dimethyl disulfide, relative to the total weight of the composition C;
between 1% and 10% by weight of at least one surfactant, relative to the total weight of the composition C; and
optionally between 0.1% and 0.5% by weight of an odour-masking agent, relative to the total weight of the composition C.

The composition C in particular comprises, or even consists of:
at least 90% by weight of fumigant, for example dimethyl disulfide, relative to the total weight of the composition C;
between 1% and 10%, preferably between 1% and 6%, by weight of at least one (C₁₀-C₁₃)alkyl-benzene sulfonate, relative to the total weight of the composition C; and
optionally between 0.1% and 0.5% by weight of an odour-masking agent, relative to the total weight of the composition C.

The formulations F and the compositions C as according to the invention may be prepared by techniques well known to the person skilled in the art. For example, the following method may be used:
preparing the composition C by simple mixing of its components, optionally with stirring and with heating, the order in which the components are added having no effect on the composition C; then
preparing the formulation F by adding water to the resulting composition C, optionally with stirring.

The formulation F may also be in a ready-to-use form.

The present inventors have found that the best balance between fumigant efficacy and even distribution in the soil and/or substrate to be treated, when drip administration is intended, is to use a particular formulation which allows a stable emulsion to be obtained.

By pesticide treatment, what is meant in particular is a treatment having at least one effect chosen from nematicidal, fungicidal, insecticidal, herbicidal and bactericidal effects, especially with regard to phytopathogenic organisms.

By substrates, what are meant, in particular, are composts, peats, rockwool, or other substrates commonly used for the growing of plants, and especially above-ground crops.

### Fumigant Compounds

Fumigant compounds are known and are widely described in the literature. Fumigants are in particular required to meet three conditions in order to be able to be used practically in soil and/or substrate disinfection:
they have overall pesticidal properties (in particular at least one property selected from nematicidal, fungicidal, herbicidal, insecticidal and bactericidal);
they are capable of diffusing rapidly throughout the thickness of the soil and/or substrate to be treated, in the form of gas; and
they lead to a gas concentration sufficient to kill the phytopathogenic organisms present.

Fumigants include, in particular:
1,3-dichloropropene, sulfuryl fluoride (SO₂F₂), phosphine, methyl iodide, chloropicrin (Cl₃C—NO₂), metam-sodium (CH₃—NHCS₂Na), sodium tetrathiocarbonate (Na₂CS₄), MITC (CH₃—NCS), dazomet (which generates MITC), AITC (allyl isothiocyanate), EDN (ethanedinitrile), and the compounds of formula (1) below, including DMDS.

International application WO 2002/074083 describes, in particular, fumigants based on sulfur compounds, and in particular the compounds conforming to the general formula (1) below:

R—S(O)ₙ—Sₓ—R′ (1)

in which R is chosen from a linear or branched alkyl radical containing from 1 to 4 carbon atoms, and a linear or branched alkenyl radical containing from 2 to 4 carbon atoms; n is equal to 0, 1 or 2; x is an integer chosen from 0, 1, 2, 3 or 4, with x preferably representing 1, 2, 3 or 4; R′ is chosen from a linear or branched alkyl radical containing from 1 to 4 carbon atoms, and a linear or branched alkenyl radical containing from 2 to 4 carbon atoms or, only when n=x=0, a hydrogen or alkali metal atom.

Non-limiting examples of radicals R and R′ include methyl, propyl, allyl and 1-propenyl radicals.

Preferably n=0, and so the compounds conform to the formula (1′):

R—S—Sₓ—R′ (1′)

in which R and R′, which are identical or different, preferably identical, represent, each independently of one another, a linear or branched alkyl or alkenyl, preferably alkyl, radical containing from 1 to 4 carbon atoms, and x represents 1, 2, 3 or 4.

One especially preferred compound according to the invention is dimethyl disulfide (DMDS).

According to one variant of the present invention, two or more fumigants may be used, as a mixture or separately, alternately or successively. Accordingly, if two or more fumigants are applied, they may be:
present together in the formulation F; or
applied alternately or successively, at least one of the fumigants being in the form of the formulation F. The formulation F may therefore be used according to the invention in combination or complementarily with other fumigants.

It is possible in particular to use, as indicated above, two or more fumigants, for example having complementary or synergistic properties, chosen from:
1,3-dichloropropene, sulfuryl fluoride (SO₂F₂), phosphine, methyl iodide, chloropicrin (Cl₃C—NO₂), metam-sodium (CH₃—NHCS₂Na), sodium tetrathiocarbonate (Na₂CS₄), MITC (CH₃—NCS), dazomet (which generates MITC), AITC (allyl isothiocyanate), EDN (ethanedinitrile), and the compounds of formula (1), and in particular the dialkyl disulfides, for example DMDS.

More preferably, the formulation F according to the invention comprises DMDS and at least one other fumigant selected from the group consisting of:
1,3-dichloropropene, sulfuryl fluoride (SO₂F₂), phosphine, methyl iodide, chloropicrin (C₁₃C—NO₂), metam-sodium (CH₃—NHCS₂Na), sodium tetrathiocarbonate (Na₂CS₄), MITC (CH₃—NCS), dazomet (which generates MITC), AITC (allyl isothiocyanate) and EDN (ethanedinitrile).

More preferably, the DMDS may be combined with 1,3-dichloropropene, chloropicrin (C₁₃C—NO₂), metam-sodium (CH₃—NHCS₂Na), AITC (allyl isothiocyanate) or EDN (ethanedinitrile); for example, the DMDS may be combined with EDN. Preferably, the DMDS may be combined with chloropicrin.

It would not be beyond the scope of the present invention to use conventional pesticides (that is, non-fumigant pesticides) in alternation or complementarily with the formulation F according to the invention.

The fumigants according to the invention, and in particular DMDS, may also be used in alternation or complementarily with new pesticides or biocides, for example of the kind described in application PCT/US2019/016448.

It is possible in particular to use sodium hypochlorate, hydrogen peroxide (H₂O₂), or a peroxide source such as peracetic acid, sodium peroxide, potassium oxide, potassium peroxide, calcium peroxide, magnesium peroxide, urea peroxide, organic hydroperoxides (RaOOH), organic peroxides (RaOORa), and superoxides, in which Ra is a linear or branched alkyl, alkenyl or alkynyl comprising from 1 to 12 carbon atoms, or is an aromatic ring preferably having 6 carbon atoms, or a combination of aromatic rings, or other compounds capable of producing reactive oxygen.

An alternate or complementary treatment of this kind may be carried out before or after application of the formulation F as according to the invention, preferably as a post-treatment.

In the context of the present invention, very particular preference is given to the formulations F comprising DMDS as the sole fumigant.

### Surfactants

The formulations F according to the invention may be obtained by adding at least one surfactant to the fumigant compound(s), then admixing the resulting mixture with a certain amount of water so as to give an emulsion, preferably a microemulsion. Very preferably, the formulations F according to the invention are aqueous emulsions (having water as solvent).

Especially suitable for the preparation of these emulsions or microemulsions are primarily hydrophilic surfactants, i.e. those having an HLB (hydrophilic lipophilic balance) of greater than or equal to 8, which may be anionic, cationic, nonionic or amphoteric in nature.

Non-limiting examples of anionic surfactants include:
alkali metal, alkaline earth metal, ammonium or triethanolamine salts of alkyl-, aryl- or alkylaryl-sulfonic acids, fatty acids of basic pH, sulfosuccinic acids or alkyl, dialkyl, alkylaryl or polyoxyethylene-alkylaryl esters of sulfosuccinic acid;
alkaline metal or alkaline earth metal salts of esters of sulfuric, phosphoric, phosphonic or sulfoacetic acid and saturated or unsaturated fatty alcohols, and also alkoxylated derivatives thereof;
alkaline metal or alkaline earth metal salts of alkylarylsulfuric, alkylarylphosphoric and alkylarylsulfoacetic acids, and also alkoxylated derivatives thereof.

Cationic surfactants which can be used are, for example, those from the class of quaternary alkylammoniums, sulfoniums or fatty amines of acidic pH, and also alkoxylated derivatives thereof. Non-limiting examples of nonionic surfactants include alkoxylated alkylphenols, alkoxylated alcohols, alkoxylated fatty acids, glycerol fatty esters or fatty derivatives of sugar.

Amphoteric surfactants which can be used are, for example, alkyl-betaines or alkyl-taurines.

Preferred surfactants for preparing the formulations F according to the invention are compounds based on alkyl-benzene sulfonate and/or on alkoxylated alkylphenol. Use is made more particularly of (C₁₀-C₁₃)alkyl-benzene sulfonates (also called salts of C₁₀-C₁₃ alkyl derivatives of benzene sulfonic acid), for example the calcium salts of C₁₀-C₁₃ alkyl derivatives of benzene sulfonic acid (CAS number 1335202-81-7), and especially mixtures thereof in any proportion. Said (C₁₀-C₁₃)alkyl-benzene sulfonates may be in a mixture or not with other surfactants, for example with nonionic surfactants, optionally in the presence of an organic solvent such as 2-ethylhexan-1-ol.

The surfactants used may be in the form of commercial compositions, for example Atlox™ 4851B sold by Croda, T-Mulz® TE-CP sold by Harcros Chemicals.

### Odour-Masking Agent:

Some fumigants have a strong, unpleasant or even aggressive odour. In particular, DMDS has a strong and aggressive odour, owing partly to the presence of highly odourous impurities and partly to the garlic and ether odour intrinsic to this molecule. The same is true of the majority of organic sulfides.

Generally speaking, the oxides of these organic sulfides, especially DMSO, have a less aggressive odour. Nevertheless, according to the concentrations of impurities, this odour may be unpleasant and troublesome for the end user.

According to the present invention, therefore, the formulation F may further comprise an odour-masking agent. Any known type of odour mask may be used. By “odour-masking agent”, what is meant is a compound or a composition comprising a number of compounds that enables the odour of the fumigant used to be reduced, suppressed or masked.

An example that may be mentioned is chloropicrin, which is generally used to odourize methyl bromide.

It is possible in particular to use an odour-masking agent as described in application WO 2011/012815, incorporated here by reference.

Said odour-masking agent may comprise at least one monoester, at least one di- and/or triester, at least one alcohol, at least one ketone and optionally at least one terpene.

According to one preferred embodiment, the odour-masking agent comprises:

a1) from 1% to 40% by weight of at least one monoester;

a2) from 10% to 70% by weight of at least one di- and/or triester;

a3) from 1% to 30% by weight of at least one alcohol;

a4) from 0.5% to 20% by weight of at least one ketone of the formula R^{a}—CO—R^{b}, in

which Ra represents a linear or branched hydrocarbon chain comprising from 1 to 6 carbon atoms, optionally comprising one or more unsaturations in the form of double bonds, and R^{b} represents a cyclic hydrocarbon chain or else a linear or branched hydrocarbon chain which is optionally, but preferably, substituted by a cyclic structure, with R^{b} comprising from 6 to 12 carbon atoms, optionally comprising one or more unsaturations in the form of double bonds, and being optionally substituted by one or more hydroxyl groups; and

a5) optionally up to 20% by weight of at least one terpene.

The percentages of a1, a2, a3, a4 and a5 are percentages by weight expressed relative to the total weight of the odour-masking agent.

Unless otherwise noted, “ppm” signifies parts per million by weight.

Said odour-masking agent may therefore comprise from 1% to 40%, preferably from 2% to 35%, more preferably from 5% to 30% by weight, relative to the total weight of the odour-masking agent, of at least one monoester stated under a1).

Illustrative but non-limiting examples of monoesters stated under a1) include the esters of saturated or unsaturated C2-C20 acids, such as ethyl, propyl, butyl, pentyl, 2-methylbutyl, isoamyl, hexyl, benzyl, phenylethyl, menthyl and carvyl acetates, propionates, butyrates, methylbutyrates, pentanoates, hexanoates, heptanoates, caproates, oleates, linoleates and linolenates, and others, and also mixtures thereof.

More particular preference is given to isoamyl acetate, hexyl acetate, 2 methylbutyl butyrate, isoamyl butyrate, benzyl acetate, phenylethyl acetate and mixtures of these compounds.

The odour-masking agent may further comprise at least one di- and/or triester a2), in an amount of between 10% and 70% by weight, preferably between 15% and 65% by weight, more preferably between 20% and 60% by weight, relative to the total weight of the odour-masking agent. Mention may be made, non-limitingly, of at least one di- and/or triester chosen from ortho-phthalates, such as diethyl ortho-phthalate; citrates, such as triethyl citrate; and malonates, such as diethyl malonate.

The odour-masking agent may further comprise from 1% to 30%, preferably from 5% to 25%, by weight, relative to the total weight of the odour-masking agent, of at least one alcohol a3), advantageously at least one monoalcohol comprising from 1 to 30 carbon atoms, preferably from 6 to 20 carbon atoms, more preferably from 8 to 11 carbon atoms, said carbon atoms forming a linear or branched chain optionally comprising one or more unsaturations in the form of double bonds, and optionally comprising a 5- or 6-membered cyclic structure which is saturated, or completely or partially unsaturated.

The alcohols defined above are preferably monoalcohols, with the hydroxyl function preferably being carried by an sp2 carbon atom. It should be understood that the hydroxyl function may also be carried by a carbon atom included in a cyclic structure as defined above.

The alcohols used in the odour-masking agent and as defined above are advantageously, and by way of non-limiting examples, chosen from menthol, neomenthol, phenylethyl alcohol, benzyl alcohol, citronellol, dihydromyrcenol, dihydroterpineol, dimetol, ethyl-linalool, geraniol, linalool, tetrahydrolinalool, tetrahydromyrcenol, nerol, and others, and also mixtures of two or more thereof.

The ketone or ketones indicated under a4) above are chosen, by way of non-limiting examples, and preferably, from damascones, damascenones, ionones, irisones, methylionones, frambinone (CAS No. 5471-51-2), and others, and also mixtures thereof. The amount of ketone(s) is advantageously between 0.5% and 20%, preferably between 1% and 10%, by weight, relative to the total weight of the odour-masking agent.

The odour-masking agent may optionally further comprise up to 20%, preferably from 1% to 10%, by weight, relative to the total weight of the odour-masking agent, of at least one terpene.

Examples of terpenes, indicated under a5), that can be used include, without limitation, terpinenes, myrcenes, limonene, terpinolene, pinenes, sabinene, camphene, and others, mixtures of two or more thereof, and also essences based on terpenes, especially those comprising these ingredients.

Furthermore, the odour-masking agent which can be used in the context of the present invention may comprise, in minor amounts, other agents (fragrances) which are commonly used in the field of perfumery, and in particular one or more compounds which carry cyclic ketone and/or aldehyde function(s), among which compounds mention may be made, without limitation, of geranial, neral, citronellal, menthone, isomenthone, 1,8-cineole, ascaridole, flavonone, and mixtures thereof.

Where appropriate and even if necessary, the odour-masking agent may further comprise one or more additives commonly used in the field. Such additives may for example be chosen from, without limitation, solvents, pigments, dyes, preservatives, biocides, and others.

Among the solvents, especially preferred examples are alcohols, ethers, esters and glycols. With particular advantage, the solvent is chosen from diethyl phthalate, ethylene glycol, propylene glycol, diethylene glycol, dipropylene glycol, polyethylene glycols, polypropylene glycols, and mixtures thereof, and more advantageously still from diethyl phthalate, dipropylene glycol, and mixtures thereof.

A typical odour-masking agent composition comprises (by weight relative to the total weight of the odour-masking agent):
from 5% to 30% by weight of at least one monoester a1), chosen from iso-amyl acetate, ethyl methyl-2-butyrate, iso-amyl butyrate, phenylethyl acetate, ethyl caproate, benzyl acetate, hexyl acetate and mixtures thereof;
from 20% to 60% by weight of at least one di- and/or triester a2) chosen from ortho-phthalates, such as diethyl ortho-phthalate; citrates, such as triethyl citrate; and malonates, such as diethyl malonate, and mixtures thereof;
from 5% to 25% by weight of at least one alcohol, preferably of at least two alcohols, more preferably of at least three alcohols, as described above under a3);
from 1% to 10% by weight of at least one ketone, preferably at least two ketones, more preferably at least three ketones, as described above under a4); and
from 1% to 10% by weight of at least one, preferably at least two, preferably a mixture of, terpenes referenced above under a5).

A representative but non-limiting example of an odour-masking agent is reproduced below, in which each of the components comprises one, a plurality, or even all of the compounds listed:

Component a1): 16.00%
comprising benzyl acetate, hexyl acetate, iso-amyl acetate,
phenylethyl acetate, ethyl caproate, ethyl methyl-2-butyrate

Component a2): 50.00%
comprising diethyl malonate, diethyl phthalate

Component a3): 20.60%
comprising phenylethyl alcohol, citronellol, geraniol, linalool,
cis-3-hexenol

Component a4): 4.50%
comprising 1-(4-hydroxyphenyl)butane-3-one, alpha-irisone

Component a5): 7.00%
orange terpenes

Others: 1.90%
comprising citral, ethylmaltol, ethylmethyl phenylglycidate

These compositions are given as examples.

### Application in Drip Fumigation

The present invention relates to the use of a formulation F as defined above for fumigating soils and/or substrates. Said formulation F is preferably administered dropwise to the soils and/or substrates to be treated.

The present invention also relates to a method for pesticide treatment by fumigation of soils and/or substrates, wherein the formulation F as defined above is administered dropwise.

Accordingly, the fumigation of soils and/or substrates according to the invention is useful for the growing of fruits, vegetables, flowers and ornamental plants, in particular for tomatoes, strawberries, melons, cucumbers, aubergines, bell peppers, potatoes, carrots, pineapples, courgettes, water melons, onions, garlic, vines, fruit trees and cut flowers.

The formulation F is particularly suitable for drip administration. It enables the solubilization of the fumigant and in particular of DMDS. The fumigant is solubilized stably, so preventing it from accumulating in the drippers and blocking them. The formulation F is, in particular, stable for at least 30 minutes. Moreover, it allows even diffusion of the fumigant over the whole of the surface to be treated and throughout the duration of the fumigation to be obtained, without underdosing or overdosing areas, the latter obviously being undesirable.

In particular, if DMDS is used under the conditions of the invention, and especially in the form of the formulation F, with drip application, it is possible to obtain maximum efficacy for this fumigant.

The treatment may be readily adapted by the person skilled in the art in accordance with the crop to be treated, the nature of the soil and/or substrate, and climatic conditions.

Drip administration may be carried out by any conventional drip irrigation system. These kinds of systems or devices for drip irrigation (also called trickle irrigation systems or micro-irrigation systems) are widely known and are generally used to provide water and optionally an irrigation liquid such as a liquid fertilizer to the plants to be cultivated in the soil of agricultural land, plantations or other substrates. According to the invention, these systems are also called drip fumigation systems when they deliver the fumigant formulation F according to the invention.

In addition to the conventional irrigation device, these systems comprise, for example, a supply and/or a reservoir for the composition C as defined above, and optionally a dosing device for said composition C.

The composition C may be supplied by any means known per se, and for example from a reservoir containing it. The reservoir may be equipped with a pump and advantageously with a plunger tube, as described in international application WO 2014/147034.

Drip application is very preferably performed by a drip irrigation device comprising a dosing device for said composition C.

Accordingly, the formulation F is advantageously prepared by the dosing device by mixing with water, at the location at which fumigation is to take place. The dosing may be carried out using an Atex pump (a pump for Explosive Atmosphere, for the use of flammable or highly flammable product) or a venturi system or a volumetric metering pump.

The dosing is advantageously carried out using a volumetric metering pump, preferably a hydraulic volumetric pump for proportional metering, preferably without electricity, such as the pumps available from Dosatron International® or from FLUIDEO®. A pump of this kind is described for example in application WO 2006/016032. Therefore, using such a pump, the dosing of the formulation F is made dependent on the flow rate of water and can therefore be constant throughout the duration of fumigation.

The drip fumigation system may in particular comprise drip lines (or pipes) connected to a main supply line, and the main supply line may be connected to the dosing device as mentioned above.

According to one embodiment, the drip lines are spaced apart from one another by approximately 20 cm to 1.5 m. Each drip line is equipped in particular with drippers, which may be spaced apart from one another by 10 cm to 50 cm and may have a flow rate of between 0.5 and 4 L/hour. The application time for the formulation F according to the invention may be between 45 min and 5 h, preferably between 1 h and 2 h.

The amount of water may be between 10 and 50 L/m², preferably between 10 and 30 L/m², for example approximately 20 L/m² of the surface to be treated. The water pressure in the dripper lines may be between 0.2 and 3 bar, preferably between 1 and 1.5 bar.

It is appreciated that the fumigating system according to the invention may be installed on the surface of the soil and/or of the substrate to be treated or may be buried in the earth, for example at a depth of between 5 cm and 2 m, preferably at a depth of between 5 cm and 80 cm.

The entirety of the lines comprising the drippers, or even the entirety of the drip fumigation system and also the soil and/or substrate to be treated, may be covered by a barrier film (that is, a film impermeable to the vapours from the fumigant or fumigants) before application of the formulation F. This makes it possible to prevent the fumigant(s) from dissipating in the atmosphere and so protect operatives and preserve the environment. There are different types of barrier film, such as SIF (semi-impermeable film), VIF (virtually impermeable film) or TIF (totally impermeable film) films that are currently used in fumigation treatments of soils and/or substrates. Said barrier film may be a photocatalytic film as described in application WO 2013/030513, or a self-adhesive or tackifying film as described in application WO 2016/075392. It is possible for example to use the NFT54-195-1/2 CL2 BARRIER-FILM film, Accolade® film and Paladin® film sold by Arkema.

The present invention also relates to a kit for drip fumigation of soils and/or substrates, comprising the composition C as defined above, and also a dosing device for said composition C, and optionally a drip device as defined above (comprising, in particular, dripper lines and a system for supply of water and of composition C).

Said kit allows the formulation F according to the invention to be prepared from the composition C, by dosing, and optionally allows it to be applied with the drip system.

Said kit may optionally comprise a barrier film as mentioned above.

### EXAMPLES

### Example 1

### Formulation F with DMDS According to the Invention, and Comparative

A composition C is mixed with water.

The composition C consists of approximately:
94.75% by weight of DMDS;
0.25% by weight of an odour-masking agent; and
5.00% by weight of surfactants based on calcium salts of C₁₀-C₁₃ alkyl derivatives of benzene sulfonic acid.

The results obtained are as follows:

| | | Observations |
|---|---|---|
| Formulation | Emulsification | After 30 minutes |
| Inventive formulation F | Microemulsion | Microemulsion |
| Between 0.10% and 0.25% by | Stable and clear | Stable and clear |
| volume of composition C | | |
| Inventive formulation F | Microemulsion | Microemulsion |
| Between 0.25% and 0.40% by | Stable, | Stable, |
| volume of composition C | slightly hazy | slightly hazy |
| Comparative formulation, strictly | Unstable emulsion, | No emulsion but 2 |
| greater than 0.40% by volume of | hazy to creamy | phases: |
| composition C | | −>clear |
| | | −>creamy |

The percentages are expressed relative to the total volume of water.

The formulations F according to the invention result in effective and stable emulsification of the DMDS.

Up to a dose of approximately 0.25% by volume of composition C, a clear microemulsion is obtained which is stable for at least 30 minutes.

Between >0.25% and 0.4% by volume of composition C, an emulsion is obtained which is slightly cloudy and which remains stable for at least 30 minutes.

For doses of composition C of greater than 0.40% by volume, emulsification is poor and the emulsion is not stable.

### Example 2

### Fumigation Treatment According to the Invention

The efficacy of the DMDS in formulation F according to the invention, alone or in combination with another fumigant, was tested on carnations cultivated on growing plots under glass in Turkey.

I. Equipment and Technique:

The trial was carried out using an experimental scheme of 6 plots chosen at random, treated with 6 different treatments with 4 tests per treatment. The size of the plots was 50 m² and the amount of water used was 20 L/m².

DMDS and/or metam-sodium were applied with water using a drip irrigation system (the DMDS with a Dosatron® pump and then the metam-sodium with an electric pump) one month before the carnations were planted out.

All of the plots treated with DMDS were covered for 4 weeks with a totally impermeable film (TIF); the plot treated with metam-sodium was covered with a polyethylene film.

The treatments were as follows:

The composition C used consists of approximately:
94.75% by weight of DMDS;
0.25% by weight of an odour-masking agent; and
5.00% by weight of surfactants based on calcium salts of C₁₀-C₁₃ alkyl derivatives of benzene sulfonic acid.

For metam-sodium, an aqueous solution (containing 510 g/L of metam-sodium) is used and is injected into a stream of water. The metam-sodium is injected after the application of the DMDS.

TABLE 2
Concentrations used

| | | JOINT APPLICATION |
|---|---|---|
| | Concentration by volume | METAM-SODIUM |
| FORMULATION | of composition C | Concentration |
| 1 | 0.30% | — |
| 2 | 0.10% | Pump injection |
| 3 | 0.15% | Pump injection |
| 4 | 0.20% | Pump injection |
| 5 | — | Pump injection |
| 6 | No treatment | No treatment |

The concentrations are expressed in % by volume relative to the total volume of water.

II. Observations and Statistical Analyses:

The soil was evaluated at 90 and 180 days after the carnations had been planted out.

The percentage mortality was evaluated in 300 plants per plot. The data were processed with the Abbot formula, and the percentage efficacy of the treatments was calculated.

The variance analysis was carried out using the Duncan test (0.05).

In the trial plots, samples were taken of the infected carnation. Using isolation studies, Fusarium spp. was determined as being the infectious disease causing the root rot in the carnations.

III. Results:

At 90 days after planting out, the following treatments had the best efficacy:
Formulation 1: 79.4% efficacy;
Formulation 3: 84.8% efficacy; and
Formulation 4: 90.9% efficacy.

At 180 days after planting out, all of the fumigation treatments had a significantly better efficacy against Fusarium spp. than the untreated control, and all of the treatments with DMDS showed markedly better control of Fusarium spp. relative to metam-sodium applied alone at 1200 L/ha.

TABLE 3
Percentage mortality and efficacy of fumigant treatments
applied dripwise on Fusarium spp.

| | 90 DAP** | | 180 DAP | |
|---|---|---|---|---|
| | % | Efficacy vs | % | Efficacy vs |
| Formulation | mortality | untreated | mortality | untreated |
| 1 | 5.08 | 79.4% | 6.25 | 86.7% |
| 2 | 9 | 63.5% | 20.25 | 56.8% |
| 3 | 3.75 | 84.8% | 10 | 78.7% |
| 4 | 2.25 | 90.9% | 6.25 | 86.7% |
| 5 | 16.33 | 33.8% | 35.5 | 24.3% |
| 6 | 24.67 | | 46.92 | — |

**DAP: Days after planting

At harvest, the best yields were obtained with formulations 1, 3 and 4 as indicated in the table above.

TABLE 4
Harvesting yield and variation in yield relative to
untreated plots

| | Yield | |
|---|---|---|
| | (number of carnation | Variation |
| Formulation | stems/plot) | in yield |
| 6 | 3 304 | — |
| 1 | 5 854 | +77% |
| 2 | 4 652 | +41% |
| 3 | 5 354 | +62% |
| 4 | 5 291 | +60% |
| 5 | 4 009 | +21% |

### CONCLUSIONS

When the concentration of composition C is between 0.10% and 0.40% by volume (relative to the total volume of water) in the drip:
application proceeds outstandingly, with excellent dissipation of the formulations in the soil;
the distribution of the formulations by dosing with the drip system enables a constant and even concentration of DMDS throughout the fumigation procedure; and
the DMDS formulations are stable throughout the fumigation procedure.

The formulations as according to the invention are therefore very well suited to drip application and enable effective and uniform pesticide treatment, without failure of the fumigating equipment.

Furthermore, tests were carried out with formulations in which the concentration of composition C was greater than 0.40% by volume.

When the Concentration of Composition C is Strictly Greater Than 0.40% by Volume (Relative to the Total Volume of Water) in the Drip:

Application was halted by a drop in pressure in the dripper lines, which had expanded. The reason is that the dripper lines (in PE for polyethylene, or in PVC for polyvinyl chloride) swell in contact with the supernatant DMDS (which is therefore less well solubilized), which is not compatible with these materials. The dripper lines swell and expand, with the possible consequence of escape of fumigant under the plastic film.

The drippers become blocked. This blockage may be caused may be caused:
by the chemical degradation of the plastics upstream of the drippers
by the swelling of a membrane present in “self-compensating” drippers (this system enables a stable flow rate in the drippers).

Treatment by drip fumigation is therefore difficult or even impossible under these conditions.

1. A method for pesticide treatment by fumigation of soils and/or substrates, in which a formulation F is administered dropwise,
the formulation F comprising water and between 0.10% and 0.40% by volume of a composition C, relative to the total volume of water in the formulation F, and
the composition C comprising:
at least 80% by weight, of at least one fumigant compound, relative to the total weight of the composition C;
between 0.1% and 20% by weight of at least one surfactant, relative to the total weight of the composition C; and
optionally an odour-masking agent.

2. The method according to claim 1, wherein the formulation F is an emulsion.

3. The method according to claim 1, wherein the formulation F comprises between 0.10% and 0.30% by volume of the composition C, relative to the total volume of water in the formulation F.

4. The method according to claim 1, wherein said the fumigant compound is chosen from the-compounds of general formula (1) below:
R—S(O)ₙ—Sₓ—R′ (1)
wherein R is selected from a linear or branched alkyl radical containing from 1 to 4 carbon atoms, and a linear or branched alkenyl radical containing from 2 to 4 carbon atoms; n is equal to 0, 1 or 2; x is an integer from 0, 1, 2, 3 or 4;
R′ selected from a linear or branched alkyl radical containing from 1 to 4 carbon atoms, and a linear or branched alkenyl radical containing from 2 to 4 carbon atoms or, only when n=x=0, a hydrogen or alkali metal atom.

5. The method according to claim 1, wherein the fumigant compound is dimethyl disulfide.

6. The method according to claim 1, wherein the composition C comprises:
at least 90% by weight of dimethyl disulfide, relative to the total weight of the composition C,
between 1% and 10% by weight of at least one surfactant, relative to the total weight of the composition C, and
optionally between 0.1% and 0.5% by weight of an odour-masking agent, relative to the total weight of the composition C.

7. The method according to claim 6, wherein the DMDS is administered as a mixture or separately with another fumigant compound selected from the group consisting of:
1,3-dichloropropene, sulfuryl fluoride (SO₂F₂), phosphine, methyl iodide, chloropicrin (Cl₃C—NO₂), metam-sodium (CH₃—NHCS₂Na), sodium tetrathiocarbonate (Na₂CS₄), methyl isothiocyanate (CH₃NCS), dazomet (tetrahydro-3,5-dimethyl-1,3,5-thiadiazine-2-thion), AITC (allyl isothiocyanate) and EDN (ethanedinitrile).

8. The method according to claim 1, wherein dropwise application is performed by a drip irrigation device comprising a dosing device for the composition C.

9. A formulation F comprising water and between 0.10% and 0.40% by volume of a composition C, relative to the total volume of water in the formulation F, and
the composition C comprising:
at least 80% by weight of at least one fumigant compound, relative to the total weight of the composition C;
between 0.1% and 20% by weight of at least one surfactant, relative to the total weight of the composition C; and
optionally an odour-masking agent.

10. A method for fumigating soils and/or substrates with the formulation F as defined in claim 1, where the formulation F is administered to the soils and/or substrates dropwise.

11. A kit for drip fumigation of soils and/or substrates, comprising the composition C as defined in claim 1, and also a dosing device for the composition C.
